(19) United States
(12) Patent Application Publication
(10) Pub. No.: US 2024/0421418 A1
(43) Pub. Date: Dec. 19, 2024

(54) Secondary Battery

(71) Applicant: LG Energy Solution, Ltd., Seoul (KR)

(72) Inventors: Dongchan Kim, Daejeon (KR); Jun Wan Kim, Daejeon (KR); Younghak Lee, Daejeon (KR)

(73) Assignee: LG Energy Solution, Ltd., Seoul (KR)

(21) Appl. No.: 18/701,475

(22) PCT Filed: May 24, 2023
(86) PCT No.: PCT/KR2023/007085

§ 371 Date: Apr. 15, 2024

(30) Foreign Application Priority Data
Jun. 2, 2022 (KR) 10-2022-0067812

(51) Int. Cl. H01M 50/342; H01M 50/107; H01M 50/152; H01M 50/186; H01M 50/578

(52) U.S. Cl. CPC H01M 50/3425; H01M 50/107; H01M 50/152; H01M 50/186; H01M 50/578

(57) ABSTRACT

The present invention relates to a secondary battery including an electrode assembly; a can that accommodates the electrode assembly; a cap assembly that includes a vent, a current interrupt device (CID) filter positioned under the vent, and a CID gasket positioned at one end of the current interrupt device filter to close an open upper portion of the can; and a gasket that is compressed while interposed between the cap assembly and the upper portion of the can to maintain insulation and sealing between the cap assembly and the can, wherein an outer surface and upper and lower surfaces of the vent of the cap assembly are in close contact with inner and upper surfaces of the gasket, respectively, and a radius of curvature of a portion where the outer surface and the upper surface of an edge portion of the vent meet is 0.3 mm or less.

### CROSS-REFERENCE TO RELATED APPLICATIONS

This application is a national phase entry under 35 U.S.C. § 371 of PCT/KR2023/007085 filed on May 24, 2023, which claims the benefit of priority based on Korean Patent Application No. 10-2022-0067812 filed on Jun. 2, 2022, all the contents of which are incorporated herein by reference.

### TECHNICAL FIELD

The present disclosure relates to a secondary battery, and more particularly, to a secondary battery in which deflection of a vent part of a cylindrical battery is improved.

### BACKGROUND ART

With the technology development and increase in demand for mobile devices, rechargeable secondary batteries have been widely used as energy sources for various mobile devices. In addition, the secondary batteries are also attracting attention as energy sources for electric vehicles, hybrid vehicles, etc., which are proposed as a solution to air pollution of existing gasoline vehicles or diesel vehicles.

The secondary battery is classified into a coin type battery, a cylindrical battery, a prismatic battery, and a pouch type battery according to a shape of a battery case in which the electrode assembly is embedded.

Among them, the cylindrical battery is configured to include an electrode assembly, a cylindrical can accommodating the electrode assembly, a cap assembly, and a gasket.

In the electrode assembly, a cathode, an anode, and a separator interposed therebetween are wound in a cylindrical shape, and cathode and anode tabs may be drawn out from the cathode and anode, respectively. Normally, the cathode tab may be drawn out upward and the anode tab may be drawn out downward.

The can is a metal container having a substantially cylindrical shape in a cylindrical secondary battery, and may be formed by a processing method such as deep drawing. Therefore, it is also possible that the can itself serves as a terminal.

The cap assembly closes an open upper portion of the can, and the cap assembly may include a vent, a current interrupt device, and the like from bottom to top. The cathode of the electrode assembly may be electrically connected to the cap assembly through the cathode tab drawn out upward, and the anode may be bonded to a bottom surface of the can through the anode tab drawn out downward. Of course, the cap assembly can be designed by reversing the polarity of the electrodes.

A gasket is positioned between the cap assembly and the can to insulate and seal therebetween.

During a cylindrical crimping/cylindrical sizing (CCR/CSZ) process of such a cylindrical battery, a dispersion of a H0 dimension may increase. The increase in the H0 dimension increases the amount of deflection of a vent, which may cause a decrease in short-circuit pressure.

Accordingly, a study on a method for improving deflection of a vent is required.

### DISCLOSURE

### Technical Problem

It is an object of the present disclosure to provide a secondary battery having an optimally shaped vent part capable of solving the problem of deflection of a vent part occurring during a CCR/CSZ process of a cylindrical battery.

### Technical Solution

To achieve the object,
a secondary battery including an electrode assembly; a can that accommodates the electrode assembly; a cap assembly that includes a vent, a current interrupt device (CID) filter positioned under the vent, and a CID gasket positioned at one end of the current interrupt device filter to close an open upper portion of the can; and a gasket that is compressed while interposed between the cap assembly and the upper portion of the can to maintain insulation and sealing between the cap assembly and the can, wherein an outer surface and upper and lower surfaces of an edge portion of the vent of the cap assembly are in close contact with inner and upper surfaces of the gasket, respectively, and a radius of curvature of a portion where the outer surface and the upper surface of the edge portion of the vent meet is 0.3 mm or less.

In an embodiment of the present invention, a radius of curvature of a portion where the outer surface and the upper surface of the edge portion of the vent meet may be 0.1 to 0.3 mm.

In an embodiment of the present invention, an adhesive layer may be formed on at least a part of the outer surface and the upper surface of the edge portion of the vent or a double-sided adhesive tape may be attached to the outer surface and the upper surface of the edge portion of the vent.

In an embodiment of the present invention, the current interrupt device (CID) filter may be bonded to an electrode tab drawn out upward from one electrode of the electrode assembly.

In an embodiment of the present invention, a metal plate at the edge portion of the vent may be overlapped in two stages by being bent upward by 180°.

In an embodiment of the present invention, the can may have a cylindrical shape, and the vent may have a flat disk shape.

### Advantageous Effects

As the secondary battery of the present disclosure has an optimally shaped vent part, deflection of a vent part occurring during a CCR/CSZ process of a cylindrical battery can be prevented.

### BRIEF DESCRIPTION OF THE DRAWINGS

FIG. 1 is a partially enlarged cross-sectional view of a cylindrical secondary battery according to an embodiment of the present invention.

FIG. 2 is a partially enlarged cross-sectional view of a cylindrical secondary battery according to another embodiment of the present invention.

FIG. 3 is a schematic diagram illustrating an analysis model according to an embodiment of the present invention.

FIG. 4 is a graph of measured values based on the analysis model according to an embodiment of the present invention.

FIG. 5 is a diagram illustrating a vent VonMises strain rate contour measured based on the analysis model according to an embodiment of the present invention.

### BEST MODE

Hereinafter, the present disclosure will be described in detail with reference to the accompanying drawings. However, the present invention may be implemented in various different forms, and is not limited to embodiments described herein.

In order to clearly describe the present disclosure, parts irrelevant to the description are omitted, and the same reference numerals are assigned to the same or similar components throughout the specification.

In addition, the terms and words used in the present specification and claims should not be construed as limited to ordinary or dictionary meaning, and should be construed in a sense and concept consistent with the technical idea of the present disclosure.

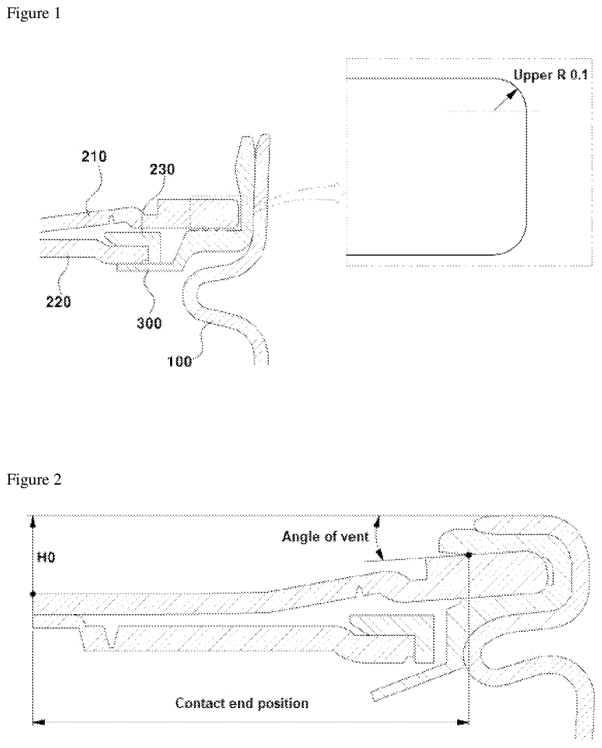

FIG. 1 is a partially enlarged cross-sectional view of a secondary battery according to an embodiment of the present invention.

Referring to FIG. 1, a secondary battery according to an embodiment of the present invention includes an electrode assembly (not shown); a can 100 that accommodates the electrode assembly; a cap assembly that includes a vent 210, a current interrupt device (CID) filter 220 positioned under the vent 210, and a CID gasket 230 positioned at one end of the current interrupt device filter 220 to close an open upper portion of the can 100; and a gasket 300 that is compressed while interposed between the cap assembly and the upper portion of the can 100 to maintain insulation and sealing between the cap assembly and the can 100.

In the secondary battery according to an embodiment of the present invention, the electrode assembly may be made in a so-called “jelly roll” form in which a cathode and an anode are usually formed in a wide plate shape to increase capacitance, and then a separator is positioned between the cathode and anode to insulate the cathode and anode, and the separator, the cathode, and the anode are stacked and wound in a circular shape. The cathode and anode may be formed by applying active material slurry to a current collector made of a metal foil or a metal mesh made of aluminum and copper, respectively. There may be an uncoated part to which the slurry is not applied at a starting end and an end of the current collector in a direction in which an electrode plate is wound. In the uncoated part, one electrode tab is installed on each electrode plate, and one of the electrode tabs may be formed to be drawn out in an upward direction which is a direction of an opening of the cylindrical can and the other may be formed to be drawn out downward from the electrode. However, the embodiment of the present invention is not limited thereto.

In the secondary battery according to the embodiment of the present invention, the can 100 has a cylindrical shape, is a container made of a lightweight conductive metal material such as aluminum or aluminum alloy, and may be formed by a processing method such as deep drawing. The electrode assembly (not shown) may be provided in the cylindrical can. In this case, a center pin (not shown) that prevents the jelly roll from unwinding and serves as a moving passage for internal gas may be inserted into an empty space in the center of the jelly roll.

In the secondary battery according to an embodiment of the present invention, the cap assembly 200 includes the vent 210, the current interrupt device filter 220, and the CID gasket 230, and as shown in FIG. 1, the current interrupt device, the CID gasket 230, and the vent 210 are positioned in order from bottom to top.

In the secondary battery according to the embodiment of the present invention, the vent 210 is positioned above the cap assembly 200. The current interrupt device (CID) is installed under the vent 210 so that a protruding part of the vent 110 is deformed convexly upward by the internal pressure to be broken.

In the secondary battery according to an embodiment of the present invention, the vent 210 may have a flat disk shape.

In the secondary battery according to an embodiment of the present invention, the edge portion of the vent 210 may be overlapped in two stages by bending the metal plate upward by 180°.

In the secondary battery according to an embodiment of the present invention, the current interrupt device filter 220 is positioned under the vent 210 and is designed to be broken according to the deformation of the vent 210.

In the secondary battery according to an embodiment of the present invention, the CID gasket 230 may function to block the current by the current blocking filter as the CID gasket falls due to pressure when the inside of the battery is filled with gas.

In the secondary battery according to an embodiment of the present invention, the gasket 300 is positioned between the upper portion of the can 100 and the cap assembly 200. The gasket 300 is compressed while being interposed between the cap assembly 200 and the upper portion of the can 100 to maintain insulation and sealing between the cap assembly 200 and the can 100. Looking at the process of closing the opening of the can 100, the gasket 300 is inserted into the can 100 to seat the cap assembly 200 on the gasket 300, and then may be subjected to a crimping process. The crimping process is a bending process in which the can 100 is sealed by applying pressure inwardly and downwardly to the upper end of the opening of the cylindrical can using a cap-up (not shown) or the like inserted inside the gasket 300 as a stopper, so the can 100, the gasket 300, and the cap assembly 200 are sealed.

In the secondary battery according to an embodiment of the present invention, an outer surface and upper and lower surfaces of the edge portion of the vent 210 of the cap assembly 200 are in close contact with the inner and upper surfaces of the gasket 300, respectively. In addition, a radius of curvature of the portion where the outer surface and the upper surface of the edge portion of the vent 210 meet is set to 0.3 mm or less.

In the secondary battery according to an embodiment of the present invention, the radius of curvature of the portion where the outer surface and the upper surface of the edge portion of the vent 210 meet may be 0.1 mm or more, 0.2 mm or more, and 0.3 mm or less, or 0.2 mm or less. When the radius of curvature of the portion where the outer surface and the upper surface of the edge portion of the vent 210 meet is limited to the above range, the sealing force between the cap assembly 200 and the gasket 300 of the secondary battery according to the present invention may be improved.

In the secondary battery according to an embodiment of the present invention, as the vent 210 upper R value increases, the contact pressure increases (the pressing amount of the gasket increases) due to the decrease in the contact area between the can 100 and the gasket 300 during the secondary crimping, and the position of a contact end between the vent 210 and the gasket 300 becomes short. As a result, the moment of the vent 210 increases while the gasket 300 presses a front end of the vent 210, which increases in a strain rate occurring in the vent 210 to increase an angle of the vent 210 and thus increase a H0 dimension.

In the secondary battery according to an embodiment of the present invention, the increase in contact pressure between the can 100 and the gasket 300 increases pressure applied to the gasket 300 to cause the gasket 300 to be further pressed, thereby increasing the vent 210 VonMises strain rate and increasing the angle of the vent 210.

In the secondary battery according to an embodiment of the present invention, an adhesive layer may be formed on at least a part of the outer surface and the upper surface of the edge portion of the vent 210 or a double-sided adhesive tape may be attached to the outer surface and the upper surface of the edge portion of the vent 210 to further increase the adhesion between the vent 210 and the gasket 300.

In the secondary battery according to an embodiment of the present invention, the current interrupt device (CID) filter 220 may be bonded to the electrode tab drawn out upward from one electrode of the electrode assembly.

Hereinafter, in order to facilitate understanding of the present invention, preferred examples are presented, but the following examples are intended only to illustrate the present invention. It will be apparent to those skilled in the art that various changes and modifications can be made within the scope and spirit of the present invention, and also it is obvious that such changes and modifications fall within the scope of the appended claims.

### EXAMPLE

### 1. Analysis Model Information

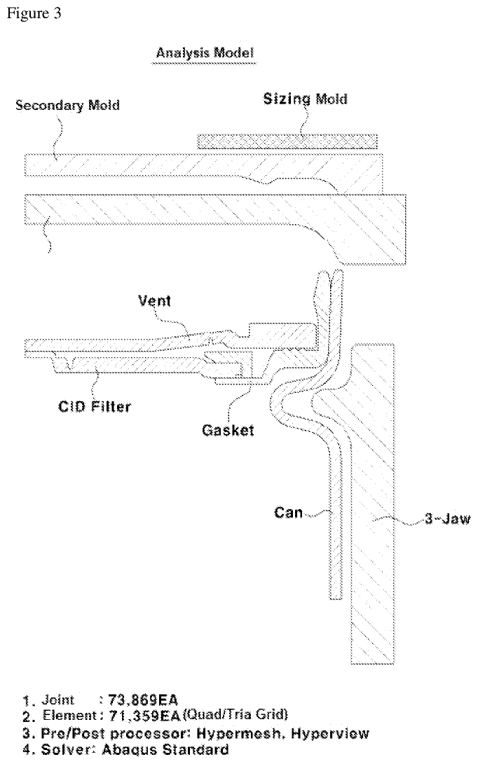

An analysis model was configured as shown in FIG. 3. In addition, load and restraint conditions are as follows. First, 2D cylindrical axis symmetric conditions were applied. Specifically, the CCR process conditions were reflected, a primary CCR height was 3.0 mm, a secondary CCR height was 2.2 mm, and a CSZ fixation conditions were also reflected. 3-Jaw, 1st/2nd mold, and sizing mold displacement movement conditions were given.

The physical properties of materials used are shown in Table 1 below.

TABLE 1

| | Material | Elastic | Poisson's | Density |
|---|---|---|---|---|
| Parts | Name | Modulus (MPa) | Ratio | (Kg/mm²) |
| Vent | Al 1050H-16 | 54,590 | 0.33 | 7.270E−06 |
| Gasket | PBT | 1,400 | 0.45 | 9.000E−07 |
| Can | NPS | 135,210 | 0.30 | 7.920E−09 |
| CID Filter | Al 1050H-16 | 61,200 | 0.33 | 2.705E−06 |
| 3 Jaw mold | Rigid Body | | | |
| 1^{st} and 2^{nd} | | | | |
| Crimping mold | | | | |
| Sizing mold | | | | |

### 2. Analysis Result

A model of the cylindrical secondary battery equipped with the can, the vent, the current interrupt device, and the CID gasket was manufactured while changing the curvature radius of the portion where the outer surface and the upper surface of the edge of the vent meet as shown in Table 2.

TABLE 2

| | Vent Upper R Value (mm) |
|---|---|
| Example 1 | 0.1 |
| Example 2 | 0.2 |
| Example 3 | 0.3 |
| Comparative | 0.4 |
| Example 1 | |

For the above model, 1) H0 dimension, 2) angle of vent, 3) vent VonMises strain rate, 4) contact pressure between a can and a gasket, and 5) position of the contact end between the vent and the gasket were measured, which was shown in the following Table 3.

TABLE 3

| | | | | | | Position |
|---|---|---|---|---|---|---|
| | | | | | | of |
| | | | | | | Contact |
| | | | | | Contact | End |
| | R value | | | | Pressure | between |
| | of Upper | | | Vent | between | Vent |
| | Portion | | Angle | VonMises | Can | and |
| | of Vent | H0 | of | Strain | and | Gasket |
| | (mm) | (mm) | Vent (°) | Rate (%) | Gasket | (mm) |
| Example 1 | 0.1 | 1.37 | 1.35 | 0.00071 | 162.45 | 8.37 |
| Example 2 | 0.2 | 1.42 | 2.20 | 0.00119 | 177.06 | 8.34 |
| Example 3 | 0.3 | 1.45 | 2.74 | 0.00143 | 189.81 | 8.31 |
| Comparative | 0.4 | 1.50 | 3.64 | 0.00156 | 215.43 | 8.21 |
| Example 1 | | | | | | |

Looking at the results of Table 3, it can be seen that the increase in the contact pressure between the can and the gasket increases the pressure applied to the gasket to cause the gasket to be further pressed, thereby increasing the vent VonMises strain rate and thus increasing the angle of the vent. When the position of the contact end between the vent and the gasket becomes short, the gasket presses the front end of the vent, so it can be seen that the vent moment increases.

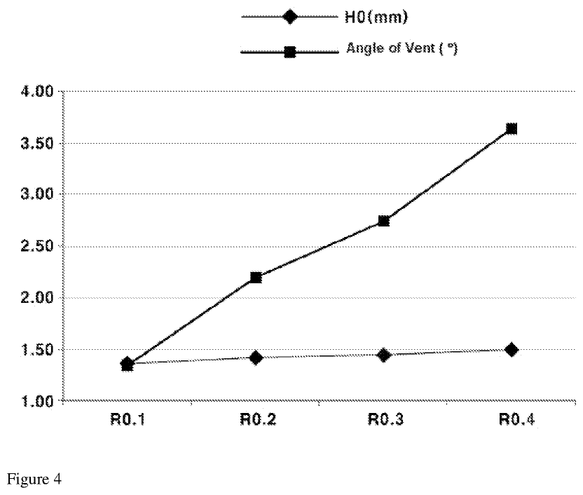

FIG. 4 showed the H0 value and the angle) (° value according to the change in the vent upper R value. The angle of the vent increases as the upper vent R value increased, so the H0 dimension tended to increase. Specifically, in the case of Comparative Example 1 having a vent upper R value of 0.4 mm, it can be seen that the vent upper R value increases by about 9.5% compared to Example 1 having a vent upper R value of 0.1 mm. Therefore, since the H0 dimension increases as the vent upper R value increases, it is determined that the R value management of the vent parts is necessary to reduce the H0 dispersion.

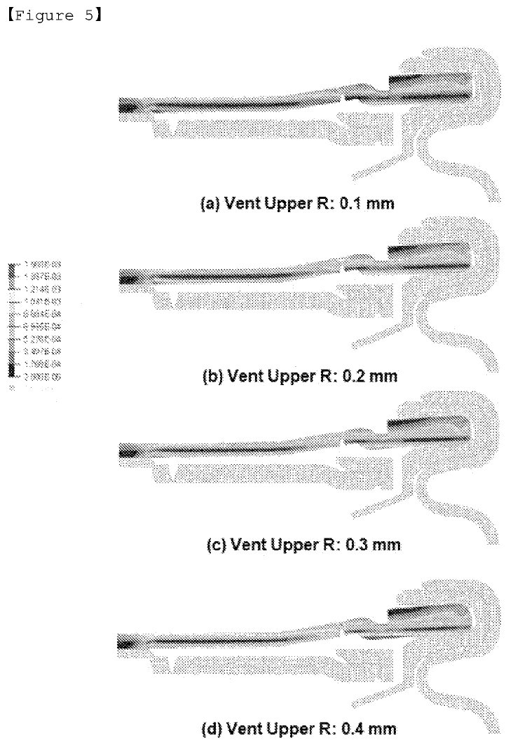

FIG. 5 showed the measured vent VonMises strain rate contour after the secondary crimping. Through this, as the vent upper R value increases, the contact pressure increases (the pressing amount of the gasket increases) due to the decrease in the contact area between the can and the gasket during the secondary crimping, and the contact end position between the vent and gasket becomes short. As a result, the vent moment increased as the gasket pressed the front end of the vent, which was determined that the angle of the vent increases due to the increase in the strain rate occurring in the vent to increase the H0 dimension.

### DESCRIPTION OF REFERENCE SIGNS

100: Can
200: Cap assembly
210: Vent
220: Current interrupt device filter
230: CID gasket
300: Gasket

1. A secondary battery, comprising:
an electrode assembly;
a can that accommodates the electrode assembly;
a cap assembly that includes a vent, a current interrupt device (CID) filter positioned under the vent, and a CID gasket positioned at one end of the current interrupt device filter to close an open upper portion of the can; and
a gasket that is compressed while interposed between the cap assembly and the upper portion of the can to maintain insulation and sealing between the cap assembly and the can,
wherein an outer surface and upper and lower surfaces of an edge portion of the vent of the cap assembly are in close contact with inner and upper surfaces of the gasket, respectively, and
a radius of curvature of a portion where the outer surface and the upper surface of the edge portion of the vent meet is 0.3 mm or less.

2. The secondary battery of claim 1, wherein the radius of curvature of the portion where the outer surface and the upper surface of the edge portion of the vent meet is 0.1 to 0.3 mm.

3. The secondary battery of claim 1, wherein an adhesive layer is formed on at least a part of the outer surface and the upper surface of the edge portion of the vent or a double-sided adhesive tape is attached to the outer surface and the upper surface of the edge portion of the vent.

4. The secondary battery of claim 1, wherein the current interrupt device (CID) filter is bonded to an electrode tab drawn out upward from one electrode of the electrode assembly.

5. The secondary battery of claim 1, wherein a metal plate at the edge portion of the vent is overlapped in two stages by being bent upward by 180°.

6. The secondary battery of claim 1, wherein the can has a cylindrical shape, and the vent has a flat disk shape.
